(19) United States
(12) Patent Application Publication
(10) Pub. No.: US 2009/0237705 A1
(43) Pub. Date: Sep. 24, 2009

(54) Error notification method, data distribution apparatus, and recording medium

(75) Inventor: Yasuyuki Ikeda, Kanagawa (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/382,469

(22) Filed: Mar. 17, 2009

(30) Foreign Application Priority Data
Mar. 18, 2008 (JP) NO. 2008-068856

(51) Int. Cl. G06K 15/00

(52) U.S. Cl. 358/1.14; 358/1.15

(57) ABSTRACT

Disclosed is an error notification method of a data distribution system that includes the steps of when detecting an occurrence of an error, referring to an error notification condition table in which an identifier of an error notification condition and an identifier of an occurrence frequency correspond to each other to specify the identifier of the occurrence frequency corresponding to the identifier of the error notification condition of the error; referring to an occurrence frequency table in which the identifier of the occurrence frequency and information on a frequency number and an occurrence interval correspond to each other to acquire the information on the occurrence number and the occurrence interval corresponding to the identifier of the occurrence frequency; and determining whether an error notification is sent based on the information on the occurrence number and the occurrence interval.

### BACKGROUND OF THE INVENTION

1. Field of the Invention

The present invention relates to a data distribution apparatus that is connected to a distribution source apparatus and a distribution destination apparatus via a network and distributes data acquired from the distribution source apparatus to the required distribution destination apparatus, a data distribution system using the data distribution apparatus, an error notification method of the data distribution apparatus, a program, and a computer-readable recording medium having the program recorded thereon.

2. Description of the Related Art

Up until now, there have been developed various data distribution systems in which an information processing terminal such as a personal computer and an image processing apparatus such as a printer, a facsimile machine, a scanner, and a digital MFP (multifunction peripheral) having plural functions thereof serving as a distribution source apparatus or a distribution destination apparatus are connected to a distribution server serving as a data distribution apparatus so as to perform communication via a network.

Generally, the data distribution apparatus in such a distribution system converts image data, electronic mails, etc., input by an external input apparatus as the distribution source apparatus into a given format and transfers them to a Notes (Registered Trademark) server, a file server, a mail server, etc., as the distribution destination apparatus. Presently, some distribution systems have an authentication server that manages the user.

To instruct the distribution of image data, etc., obtained when a document is scanned by the external input apparatus in the data distribution system using the data distribution apparatus, the user selects a required destination (display name) from a destination list displayed on the operations panel of the external input apparatus.

In the distribution server generally used as the data distribution apparatus, plural destinations are registered and the information items of notification destinations corresponding to the destinations are managed. Therefore, the distribution server specifies the notification destination corresponding to the destination selected by the external input apparatus and distributes converted image data, etc., to the notification destination (distribution destination apparatus). Alternatively, when receiving an electronic mail having an attached file from the external input apparatus, the distribution server specifies the notification destination corresponding to the address of the sending source and distributes the attached file to it.

As described above, the distribution server manages the plural destinations and the notification destinations (distribution destination apparatuses). Therefore, in some cases, an information processing apparatus such as a personal computer for a manager is provided for each destination from the viewpoint of reducing management loads. More specifically, an information processing apparatus for a manager that manages the destinations of persons belonging to departments is provided for each department.

When an error occurs in a cooperated apparatus in such a data distribution system, an error content is recorded in a log and an error notification is distributed to the notification destinations of the information processing apparatus for the manager of the distribution server.

For example, Patent Document 1 discloses a document management system in which when an error occurs in the distribution of an electronic mail between an information processing terminal and a document management server, error information is sent to the information processing terminal.

Patent Document 1: JP-A-2006-340332

However, in the conventional data distribution apparatus and the data distribution system, when an error occurs in a cooperated apparatus, error notifications on all the errors are sent (distributed) to notification destinations corresponding to the destinations of the information processing apparatus for the manager of the distribution server. Therefore, if an error frequently occurs, the manager is burdened with a heavy work load.

For example, when the user is obliged to change his/her password for the data distribution system on the first day of every month, an “authentication error” may frequently occur at the beginning of the month. Therefore, techniques for reducing the occurrence of the authentication error have been demanded.

### SUMMARY OF THE INVENTION

Accordingly, the present invention has been made to solve the above problem and may have an object of properly selecting the distribution destination and the frequency of an error notification by using a data distribution apparatus and a data distribution system to reduce working loads when a manager uses the data distribution apparatus.

According to an aspect of the present invention, there is provided an error notification method of a data distribution system in which a data distribution apparatus is connected to a distribution source apparatus and a distribution destination apparatus via a network and distributes data acquired from the distribution source apparatus to the required distribution destination apparatus. The method includes the steps of when detecting an occurrence of an error, referring to an error notification condition table in which an identifier of an error notification condition and an identifier of an occurrence frequency correspond to each other to specify the identifier of the occurrence frequency corresponding to the identifier of the error notification condition of the error; referring to an occurrence frequency table in which the identifier of the occurrence frequency and information on a frequency number and an occurrence interval correspond to each other to acquire the information on the occurrence number and the occurrence interval corresponding to the identifier of the occurrence frequency; and determining whether an error notification is sent based on the information on the occurrence number and the occurrence interval.

According to another aspect of the present invention, there is provided a data distribution apparatus that is connected to a distribution source apparatus and a distribution destination apparatus via a network and distributes data acquired from the distribution source apparatus to the required distribution destination apparatus. The apparatus includes a storage unit that stores an error notification condition table in which an identifier of an error notification condition and an identifier of an occurrence frequency correspond to each other and an occurrence frequency table in which the identifier of the occurrence frequency and information on an occurrence number and an occurrence interval correspond to each other; and an error processing unit that, when detecting an occurrence of an error, refers to the error notification condition table of the storage unit to specify the identifier of the occurrence frequency corresponding to the identifier of the error notification condition of the error, refers to the occurrence frequency table of the storage unit to acquire the information on the occurrence number and the occurrence interval corresponding to the specified identifier of the occurrence frequency, and determines whether an error notification is sent based on the information on the occurrence number and the occurrence interval.

According to still another aspect of the present invention, there is provided a computer-readable recording medium having recorded thereon a program. The program causes a computer of a data distribution apparatus, which is connected to a distribution source apparatus and a distribution destination apparatus via a network and distributes data acquired from the distribution source apparatus to the required distribution destination apparatus, to perform, when detecting an occurrence of an error, a processing step of referring to an error notification condition table in which an identifier of an error notification condition and an identifier of an occurrence frequency correspond to each other to specify the identifier of the occurrence frequency corresponding to the identifier of the error notification condition of the error; a processing step of referring to an occurrence frequency table in which the identifier of the occurrence frequency and information on a frequency number and an occurrence interval correspond to each other to acquire the information on the occurrence number and the occurrence interval corresponding to the identifier of the occurrence frequency; and a processing step of determining whether an error notification is sent based on the information on the occurrence number and the occurrence interval.

Other objects, features and advantages of the present invention will become more apparent from the following detailed description when read in conjunction with the accompanying drawings.

### BRIEF DESCRIPTION OF THE DRAWINGS

FIG. 1 is a block diagram showing the configurations of a data distribution apparatus and a data distribution system using the data distribution apparatus according to a first embodiment of the present invention;

FIG. 2 is a diagram showing an example of an error notification condition table used in the first embodiment;

FIG. 3 is a diagram showing an example of an occurrence frequency table used in the first embodiment;

FIG. 4 is a diagram showing an example of an error log table used in the first embodiment;

FIG. 5 is a flowchart showing a processing procedure performed by an error processing unit of the data distribution apparatus at the occurrence of an error according to the first embodiment of the present invention;

FIG. 6 is a diagram showing an example of an error notification condition table used in the first embodiment;

FIG. 7 is a diagram showing another example of a continuous occurrence condition table used in the first embodiment;

FIG. 8 is a flowchart showing a processing procedure performed by the error processing unit of the data distribution apparatus at the occurrence of an error according to a second embodiment of the present invention;

FIG. 9 is a diagram showing an example of the error notification condition table used in the second embodiment;

FIG. 10 is a flowchart showing a processing procedure performed by the error processing unit of the data distribution apparatus at the occurrence of an error according to a third embodiment of the present invention;

FIG. 11 is a block diagram showing the configurations of the data distribution apparatus and the data distribution system using the data distribution apparatus according to a fourth embodiment of the present invention;

FIG. 12 is a diagram showing another example of the error notification condition table used in the fourth embodiment;

FIG. 13 is a diagram showing an example of a job queue table used in the fourth embodiment;

FIG. 14 is a flowchart showing a processing procedure performed by the error processing unit of the data distribution apparatus at the occurrence of an error according to the fourth embodiment of the present invention;

FIG. 15 is a flowchart showing a processing procedure performed by a notification job scheduler of the data distribution apparatus according to the fourth embodiment;

FIG. 16 is a diagram showing an example of the notification contents of an error notification according to the fourth embodiment;

FIG. 17 is a block diagram showing the configurations of the data distribution apparatus and the data distribution system using the data distribution apparatus according to a fifth embodiment of the present invention;

FIG. 18 is a diagram showing an example of an operations screen of an external input apparatus according to the fifth embodiment of the present invention;

FIG. 19 is a diagram showing an example of the error log table used in the fifth embodiment;

FIG. 20 is a diagram showing an example of a destination information table used in the fifth embodiment;

FIG. 21 is a diagram showing an example of an input type information table used in the fifth embodiment;

FIG. 22 is a diagram showing an example of an input equipment information table used in the fifth embodiment;

FIG. 23 is a diagram showing an example of an input mail server information table used in the fifth embodiment;

FIG. 24 is a diagram showing an example of a distribution server manager information table used in the fifth embodiment;

FIG. 25 is a diagram showing an example of an authentication server manager information table used in the fifth embodiment;

FIG. 26 is a diagram showing an example of an output type information table used in the fifth embodiment;

FIG. 27 is a diagram showing an example of an output mail server information table used in the fifth embodiment;

FIG. 28 is a diagram showing an example of an output printer information table used in the fifth embodiment;

FIG. 29 is a diagram showing an example of an output document management server information table used in the fifth embodiment;

FIG. 30 is a flowchart showing a processing procedure performed by the error processing unit of the data distribution apparatus at the occurrence of an error according to the fifth embodiment of the present invention;

FIG. 31 is a diagram showing an example of an error notification mail according to the fifth embodiment;

FIG. 32 is a diagram showing an example of an exception condition information table used in the fifth embodiment; and

FIG. 33 is a flowchart showing a processing procedure performed by the error processing unit of the data distribution apparatus at the occurrence of an error according to a sixth embodiment of the present invention.

### DETAILED DESCRIPTION OF THE PREFERRED EMBODIMENTS

Hereinafter, referring to the accompanying drawings, a description is specifically made of the best mode for carrying out embodiments of the present invention.

### First Embodiment

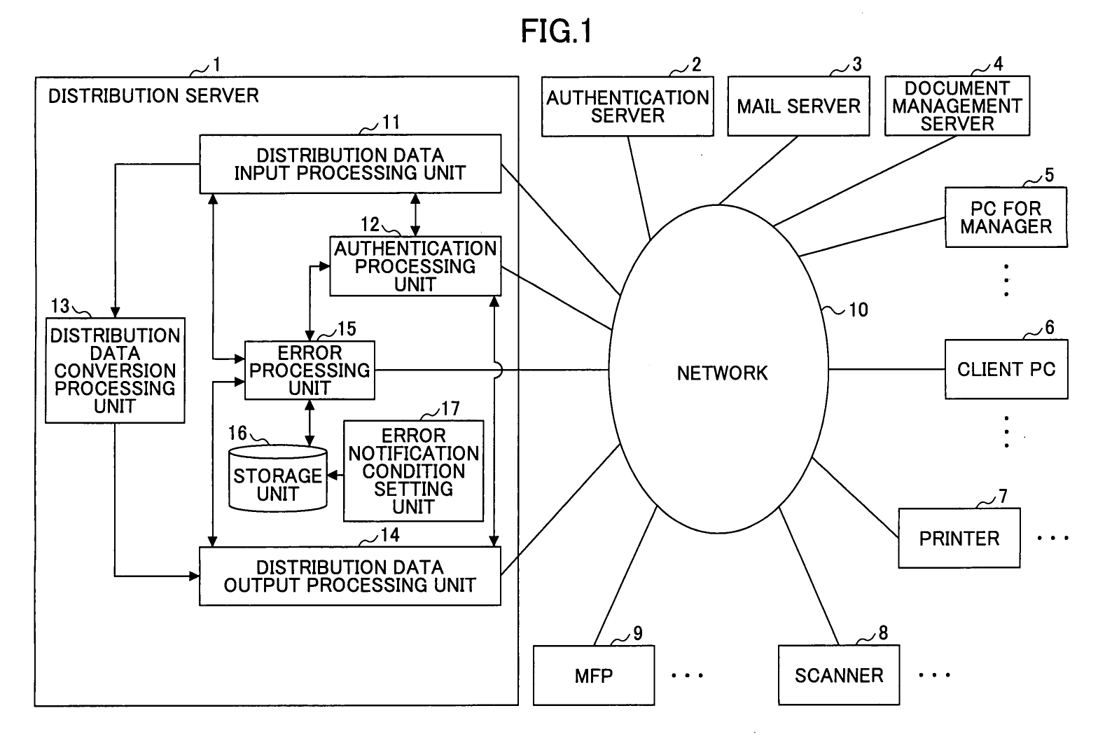

FIG. 1 is a block diagram showing the configurations of a data distribution apparatus and a data distribution system using the data distribution apparatus according to a first embodiment of the present invention.

In this data distribution system, a distribution server 1 serving as the data distribution apparatus is connected to information processing apparatuses such as an authentication server 2, a mail server 3, a document management server 4, a personal computer 5 (hereinafter referred to as a “PC”) for a manager, an information processing apparatus such as a client PC 6, and connected to image processing apparatuses such as a printer 7, a scanner 8, and a digital multi-function peripheral (MFP) 9 so as to perform data communication via a network 10. Here, the information processing apparatuses and the image processing apparatuses serve as either distribution source apparatuses or distribution destination apparatuses.

The distribution server 1 has a distribution data input processing unit 11, an authentication processing unit 12, a distribution data conversion processing unit 13, a distribution data output processing unit 14, an error processing unit 15, a storage unit 16, and an error notification condition setting unit 17. The error notification condition setting unit 17 is implemented by a user interface.

The distribution server 1 has the function of distributing image data, etc. For example, the distribution server 1 distributes image data obtained by performing scanning with the MFP 9, etc., serving as the distribution source apparatus to a predetermined notification destination (distribution destination apparatus) managed in advance.

The authentication server 2 determines the availability of the distribution server 1 when the user requests the use of the distribution server 1 via the client PC 6, etc. Only the client PC 6, etc., authenticated by the authentication server 2 can use the function of the distribution server 1.

The mail server 3 distributes electronic mail. Some mail servers, which use a SMTP (simple mail transfer protocol) for sending and receiving electronic mail via, for example, the Internet, may be referred to as a SMTP server.

The document management server 4 registers, searches for, and sends document files in response to a request from the client PC 6 sent via the network 10.

The PC 5 for a manager generally serves as an object to which an error notification is sent from the distribution server 1, for example, when an error occurs in any server connected to the distribution server 1 via the network 10. However, in the first embodiment, loads due to an error notification are distributed by the processing described below.

The client PC 6 is a personal computer through which the user performs various operations. For example, when the user issues a printing request, the client PC 6 sends the request to the distribution server 1 to instruct the printer 7, etc., to perform printing operations.

The printer 7, the scanner 8, and the MFP 9 are exemplified as image processing apparatuses. The printer 7 has a printing function. The scanner 8 has a scanning function. The MFP 9 is a multi-function image processing apparatus having the plural functions of a printer, a copier, a facsimile machine, and a scanner. For example, the MFP 9 requests the distribution server 1 to distribute image data obtained by performing scanning with its scanning function in response to instructions from the client PC 6.

In the distribution server 1, the distribution data input processing unit 11 receives distribution data such as image data from the input sources such as the client PC 6, the scanner 8, and the MFP 9 and supplies the received distribution data to the distribution data conversion processing unit 13, etc. The distribution data conversion processing unit 13 converts the distribution data into data with a specified conversion method (e.g., PDF, OCR) and supplies the converted distribution data to the distribution data output processing unit 14. The distribution data output processing unit 14 distributes the converted distribution data to a specified notification destination with a specified sending method. For example, the distribution data output processing unit 14 sends the distribution data to the sending destination “sss@bbb.com” with the sending method “SMTP mail” or sends the same to the sending destination “¥¥Server¥Folder1” with the sending method “document management server distribution.”

The error processing unit 15 performs error processing and notification determination processing when an error occurs. The error processing and the notification determination processing are described below. The authentication processing unit 12 performs predetermined authentication processing when various requests are made, or it performs processing according to authentication results by the authentication server 2. The storage unit 16 stores an error notification condition table, an occurrence frequency table, and an error log table. Next, the respective tables are described in detail.

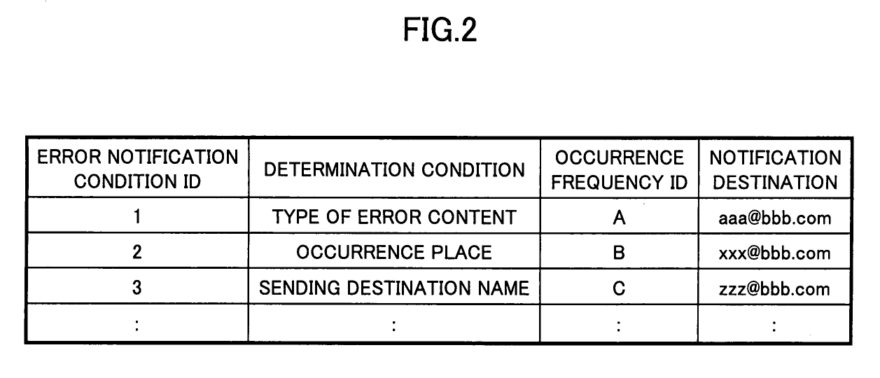

FIG. 2 is a diagram showing an example of the error notification condition table.

In the error notification condition table, error notification condition information items are managed. In the error notification condition table, in other words, error notification condition IDs, determination conditions, occurrence frequency IDs, and notification destinations as the error notification condition information items are managed so as to correspond to each other. The error notification condition ID represents the identifiers of error notification conditions. The determination condition represents conditions for determining the necessity of sending an error notification, where the column names of the error log table, etc., described below are input. For example, the column names include the types of error contents, occurrence places, sending destination names, etc. The occurrence frequency ID represents identifiers showing a relationship with the occurrence frequency table described below. The notification destination represents notification destinations corresponding to the respective error notification condition IDs.

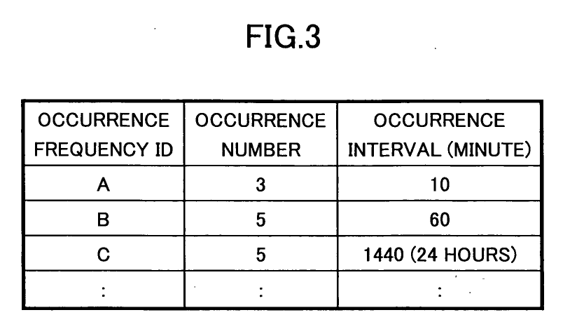

FIG. 3 is a diagram showing an example of the occurrence frequency table.

In the occurrence frequency table, occurrence frequency information items are managed. In the occurrence frequency table, in other words, occurrence frequency IDs, occurrence numbers, and occurrence intervals (calculated by minutes in this example) as the occurrence frequency information items are managed so as to correspond to each other. The occurrence frequency ID represents the identifiers of occurrence frequencies, thereby showing the relationship with the error notification condition table. The occurrence number represents the number of error occurrences. The occurrence interval represents time intervals between the occurrences of errors. For example, according to the occurrence frequency information in which the occurrence frequency ID is A, it is so defined that error notification processing is performed on the condition that an error occurs three times in 10 minutes.

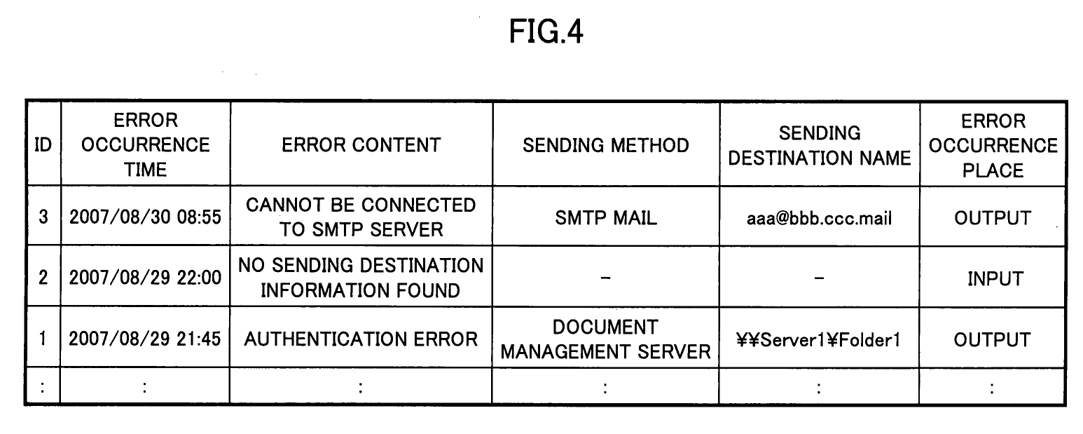

FIG. 4 is a diagram showing an example of the error log table.

In the error log table, error information items are managed. In the error log table, in other words, IDs, error occurrence times, error contents, sending methods, sending destination names, and error occurrence places as the error information items are managed so as to correspond to each other. The ID represents the identifiers of the error information. The error occurrence time represents times when errors actually occur. The error content represents specific error contents as represented, for example, by “cannot be connected to SMTP server” or “no sending destination information found.” The sending method represents specific sending methods such as the SMTP mail and the document server distribution. The sending destination name represents the names of sending destinations sent according to the respective sending methods. The error occurrence places show an input and an output.

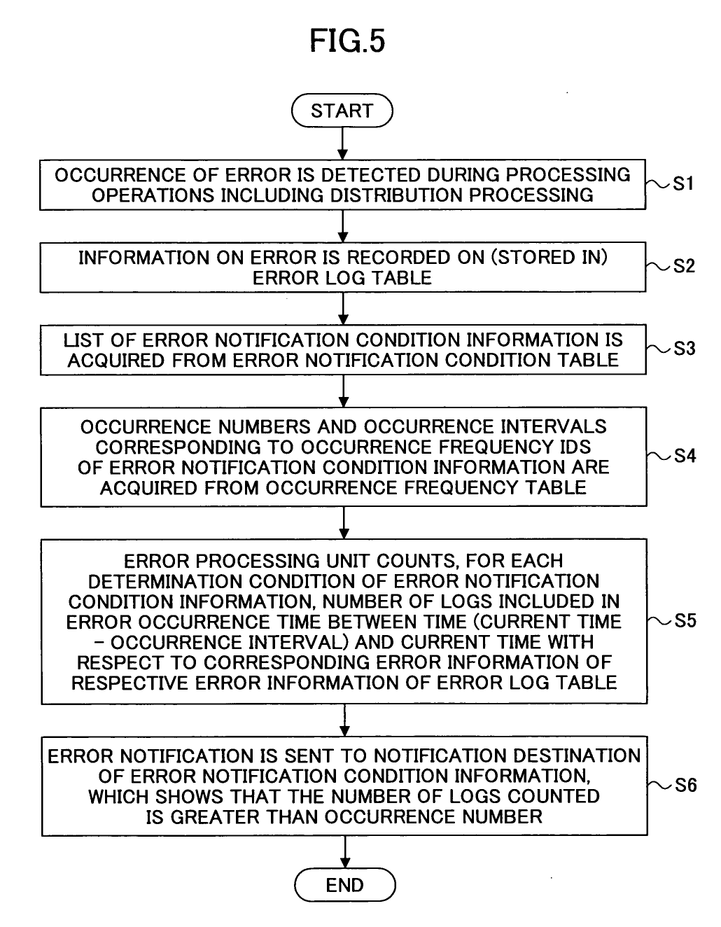

FIG. 5 is a flowchart showing a processing procedure performed by the error processing unit 15 of the data distribution apparatus at the occurrence of an error according to the first embodiment shown in FIG. 1.

In step S1, the occurrence of the error is detected during processing operations including distribution processing.

In step S2, information on the error is recorded in (stored in) the error log table of the storage unit 16.

In step S3, a list of error notification condition information is acquired from the error notification condition table stored in the storage unit 16.

In step S4, the occurrence number and the occurrence interval corresponding to the occurrence frequency ID of the error notification condition information are acquired from the occurrence frequency table stored in the storage unit 16.

The error processing unit 15 counts, for each determination condition of the error notification condition information, the number of logs included in the error occurrence time between the time (current time−occurrence interval) and the current time with respect to the corresponding error information of the respective error information of the error log table stored in the storage unit 16. In step S6, an error notification is sent to the notification destination of the error notification condition information, which shows that the number of logs counted is greater than the occurrence number.

Thus, the processing at the occurrence of the error is completed.

### Second Embodiment

Next, a description is made of a second embodiment of the present invention.

The configurations of the data distribution apparatus and the data distribution system using the data distribution apparatus of the second embodiment are the same as those of the first embodiment. Therefore, the respective components of the data distribution apparatus and the data distribution system of the second embodiment are denoted by the same reference numerals.

In the distribution server 1 as the data distribution apparatus of the second embodiment, a continuous occurrence condition table is stored in the storage unit 16 instead of the occurrence frequency table. Accordingly, the error notification condition information of the error notification condition table is partially modified.

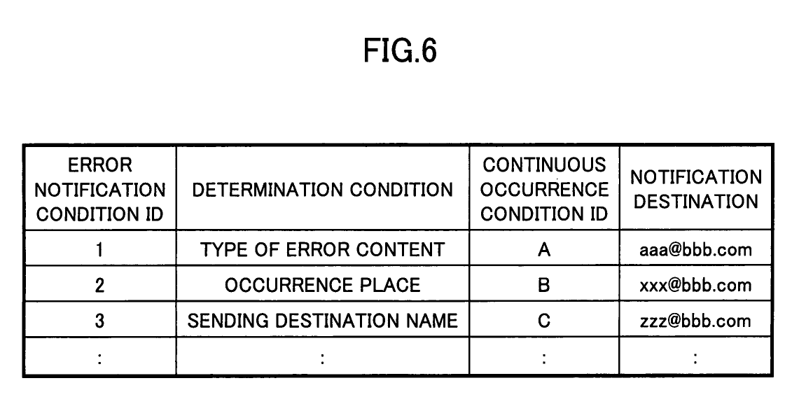

FIG. 6 is a diagram showing an example of the error notification condition table.

The error notification condition table of FIG. 6 is different from the error notification condition table of FIG. 2 in that continuous occurrence condition IDs are managed as the error notification condition information instead of the occurrence frequency IDs. The continuous occurrence condition ID represents identifiers showing a relationship with the continuous occurrence condition table described below.

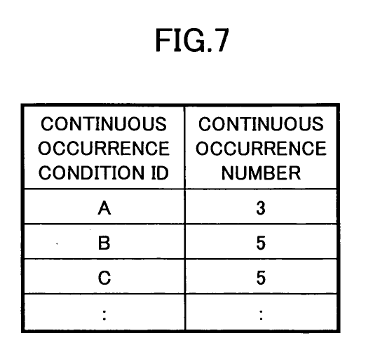

FIG. 7 is a diagram showing an example of the continuous occurrence condition table.

In the continuous occurrence condition table, continuous occurrence condition information items are managed. In the continuous occurrence condition table, in other words, continuous occurrence condition IDs and continuous occurrence numbers as the continuous occurrence condition information items are managed so as to correspond to each other. The continuous occurrence condition ID represents identifiers showing the relationship with the error notification condition table of FIG. 6. The continuous occurrence number represents determination conditions for performing error notification determination.

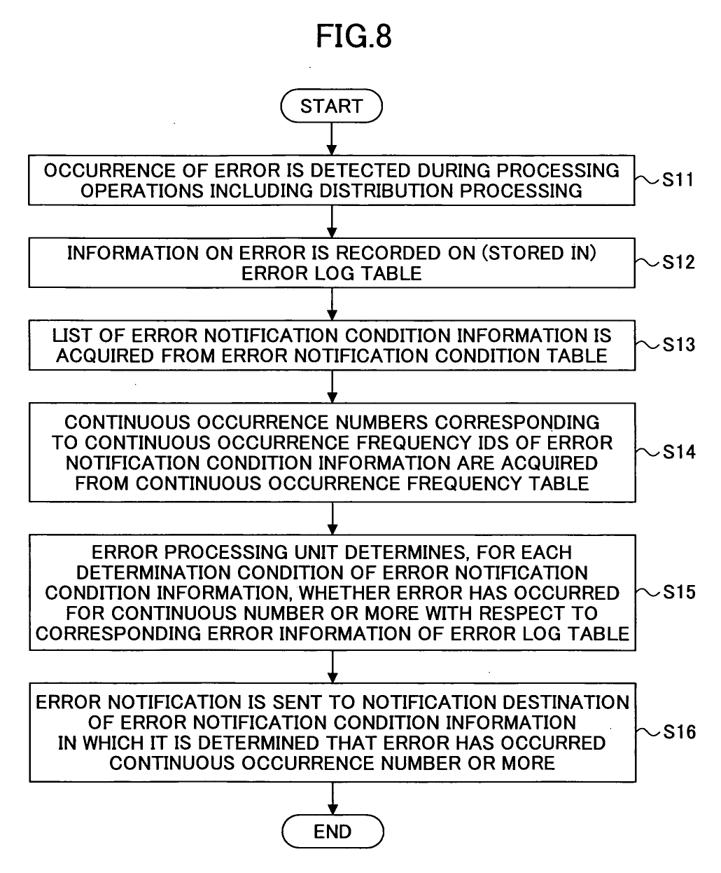

FIG. 8 is a flowchart showing a processing procedure performed by the error processing unit 15 of the data distribution apparatus at the occurrence of an error according to the second embodiment.

In step S11, the occurrence of the error is detected during processing operations including distribution processing. In step S12, information on the error is recorded in (stored in) the error log table of the storage unit 16.

In step S13, a list of error notification condition information is acquired from the error notification condition table stored in the storage unit 16.

In step S14, the continuous occurrence number corresponding to the continuous occurrence frequency ID of the error notification condition information is acquired from the continuous occurrence frequency table stored in the storage unit 16.

In step S15, the error processing unit 15 determines, for each determination condition of the error notification condition information, whether an error has occurred for a continuous number or more in corresponding error information of the error log table stored in the storage unit 16.

In step S16, an error notification is sent to the notification destination of the error notification condition information, which shows that the error has occurred for the continuous number or more.

Thus, the processing at the occurrence of the error is completed.

### Third Embodiment

Next, a description is made of a third embodiment of the present invention.

The configurations of the data distribution apparatus and the data distribution system using the data distribution apparatus of the third embodiment are the same as those of the first embodiment. Therefore, the respective components of the data distribution apparatus and the data distribution system of the third embodiment are denoted by the same reference numerals.

In the distribution server 1 as the data distribution apparatus of the third embodiment, the column of notification determination methods is added to the error notification condition table stored in the storage unit 16. Based on the contents of the notification determination methods and notification determination method IDs, either the occurrence frequency table (FIG. 3) or the continuous occurrence condition table (FIG. 7) described above is referred to.

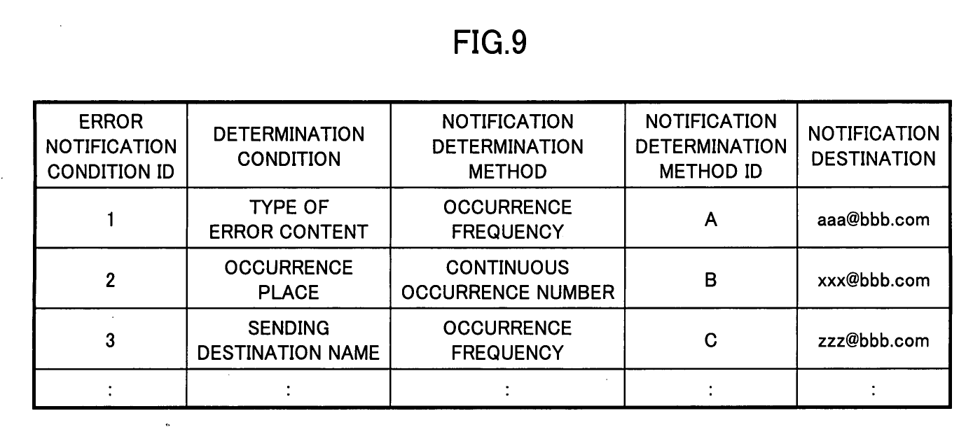

FIG. 9 is a diagram showing an example of the error notification condition table.

The error notification condition table of FIG. 9 is different from the error notification condition table of FIG. 2 in that it includes the column of the notification determination methods and manages the notification determination method IDs instead of the occurrence frequency IDs as the error notification condition information. In the column of the notification determination methods, an occurrence frequency, a continuous occurrence number, etc., are input.

When the occurrence frequency is specified in the column of the notification determination methods of the error notification condition table, the occurrence frequency table (FIG. 3) is referred to. At this time, the notification determination method IDs correspond to the occurrence frequency IDs. Therefore, the information on the corresponding occurrence numbers and occurrence intervals is acquired based on the notification determination method IDs. On the other hand, when the continuous occurrence number is specified in the column of the notification determination methods, the continuous occurrence condition table (FIG. 7) is referred to. At this time, the notification determination method IDs correspond to the continuous occurrence condition IDs. Therefore, the information on the corresponding continuous occurrence numbers is acquired based on the notification determination method IDs.

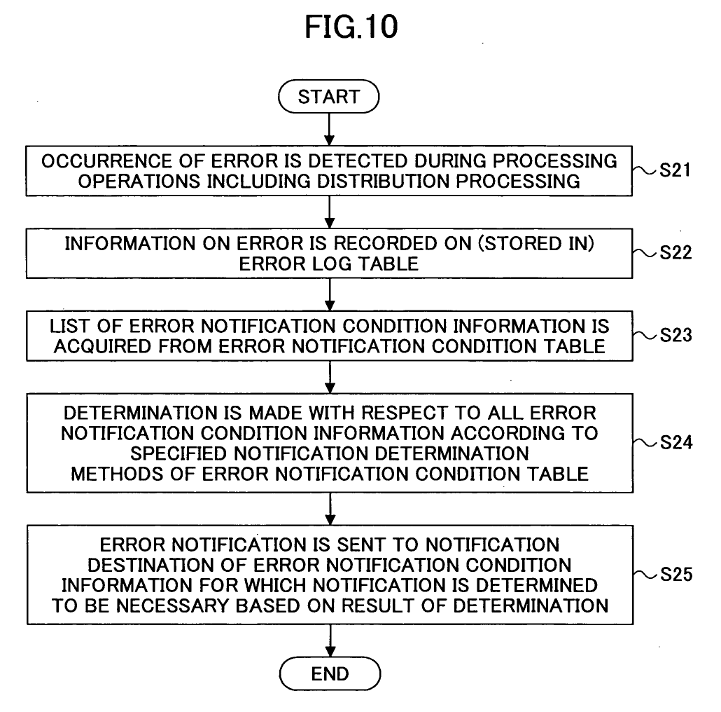

FIG. 10 is a flowchart showing a processing procedure performed by the error processing unit 15 of the data distribution apparatus at the occurrence of an error according to the third embodiment.

In step S21, the occurrence of the error is detected during processing operations including distribution processing. In step S22, information on the error is recorded in (stored in) the error log table of the storage unit 16.

In step S23, a list of error notification condition information is acquired from the error notification condition table stored in the storage unit 16.

In step S24, determination is made with respect to all the error notification condition information according to the specified notification determination methods of the error notification condition table. For example, when the notification determination method is based on the “occurrence frequency,” the determination is made by referring to the occurrence frequency table. Furthermore, when the notification determination method is based on the “continuous occurrence number,” the determination is made by referring to the continuous occurrence condition table.

In step S25, an error notification is sent to the notification destination of the error notification condition information for which the notification is determined to be necessary.

Thus, the processing at the occurrence of the error is completed.

### Fourth Embodiment

Next, a description is made of a fourth embodiment of the present invention.

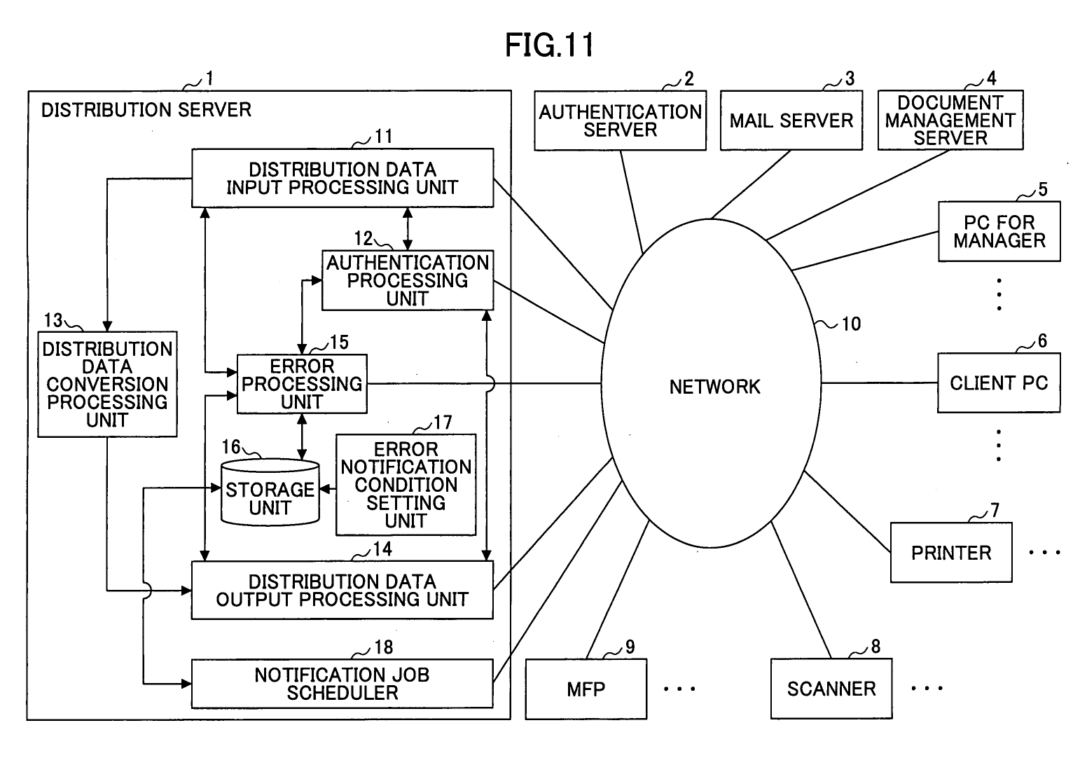

FIG. 11 is a block diagram showing the configurations of the data distribution apparatus and the data distribution system using the data distribution apparatus according to the fourth embodiment.

The configurations of the data distribution apparatus and the data distribution system using the data distribution apparatus of the fourth embodiment are substantially the same as those of the first embodiment, except that the distribution server 1 as the data distribution apparatus of the fourth embodiment has a notification job scheduler 18. The notification job scheduler 18 regularly monitors the notification job queue table described below and notifies of an error at the notification time specified according to notification information (notification job). Furthermore, the respective components of the data distribution apparatus and the data distribution system of the fourth embodiment corresponding to those of the first embodiment are denoted by the same reference numerals.

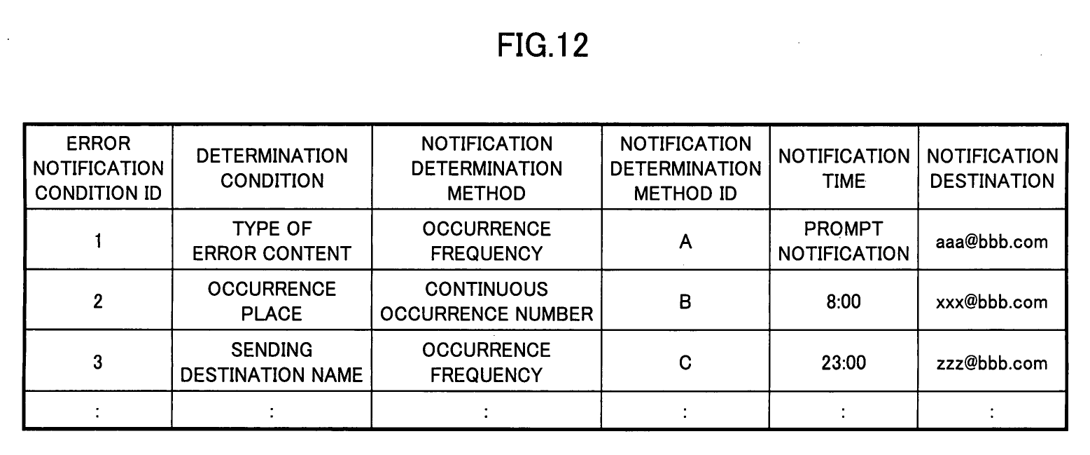

FIG. 12 is a diagram showing an example of the error notification condition table used in the fourth embodiment. The error notification condition table of FIG. 12 is different from the error notification condition table of FIG. 9 in that it includes the column of notification times. When the error processing unit 15 promptly notifies of an error after the occurrence of the error, a notification time is specified as “prompt notification” in the column of the notification times. On the other hand, when the error processing unit 15 notifies of an error at a prescribed time after the occurrence of the error, the prescribed time is shown in the column of the notification times.

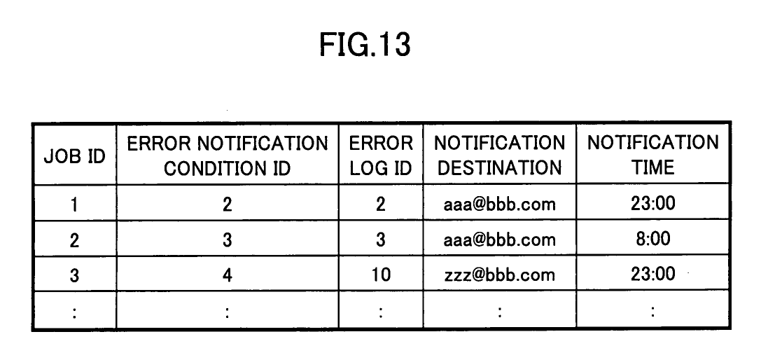

FIG. 13 is a diagram showing an example of the job queue table used in the fourth embodiment. In the job queue table, notification information items are managed. In other words, job IDs, error notification condition IDs, error log IDs, notification destinations, and notification times as the notification information items are managed. With the error notification condition IDs, the job queue table has a relationship with the error notification condition table of FIG. 12. The job ID represents identifiers for identifying notification jobs. The error log ID represents identifiers for identifying error logs.

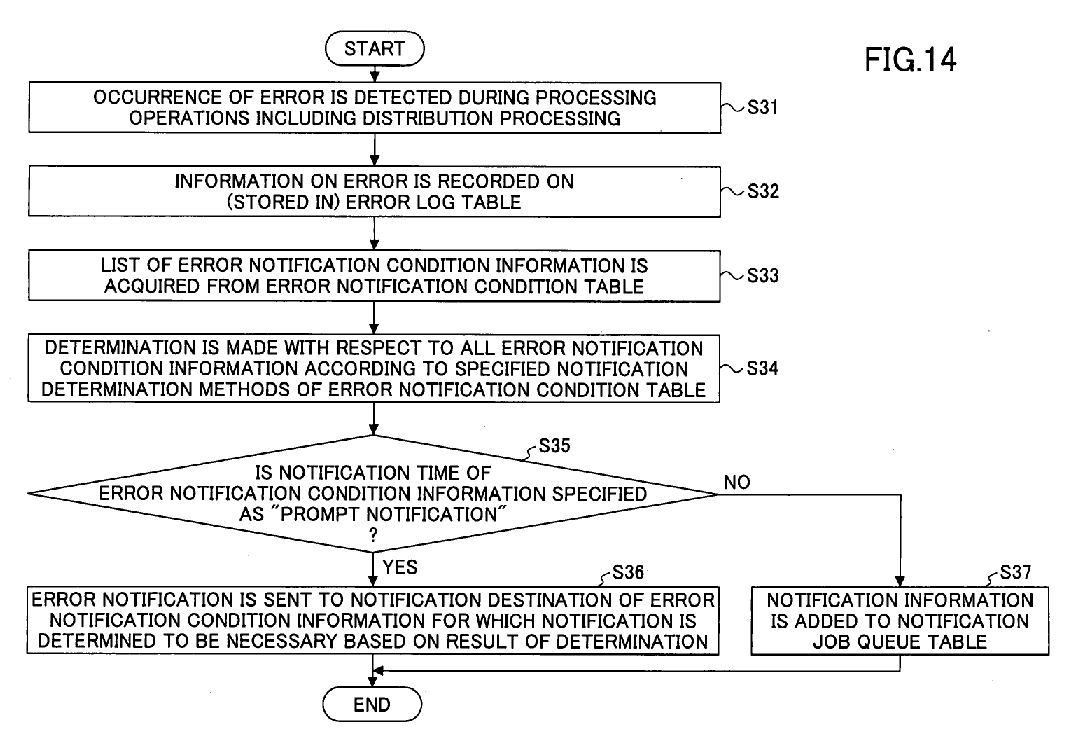

FIG. 14 is a flowchart showing a processing procedure performed by the error processing unit 15 of the data distribution apparatus at the occurrence of an error according to the fourth embodiment.

In step S31, the occurrence of the error is detected during processing operations including distribution processing. In step S32, information on the error is recorded in (stored in) the error log table of the storage unit 16.

In step S33, a list of error notification condition information is acquired from the error notification condition table stored in the storage unit 16.

In step S34, determination is made with respect to all the error notification condition information according to the specified notification determination methods of the error notification condition table. For example, when the notification determination method is based on the “occurrence frequency,” the determination is made by referring to the occurrence frequency table. Furthermore, when the notification determination method is based on the “continuous occurrence number,” the determination is made by referring to the continuous occurrence condition table.

In step S35, it is determined whether the notification time of the error notification condition information is specified as the “prompt notification.” When it is determined that the notification time is specified as the “prompt notification” in step S35, the process proceeds to step S36.

In step S36, an error notification is sent to the notification destination of the error notification condition information for which the notification is determined to be necessary based on a result of the determination.

On the other hand, when it is determined that the notification time is not specified as the “prompt notification,” the process proceeds to step S37. In step S37, the notification information is added to the notification job queue table stored in the storage unit 16.

Thus, the processing at the occurrence of the error is completed.

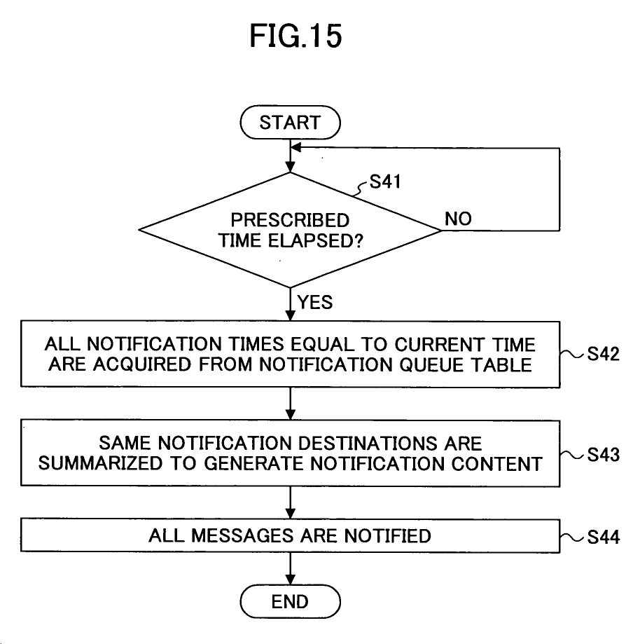

FIG. 15 is a flowchart showing a processing procedure performed by the notification job scheduler 18 of the distribution server 1 shown in FIG. 11.

After the addition of the notification information in step S37 of FIG. 14, the notification job scheduler 18 performs the following processing based on the notification job queue table.

In step S41, it is determined whether a prescribed time has elapsed. In other words, the notification job scheduler 18 is in a standby status until the prescribed time has elapsed. When the prescribed time has elapsed, the process proceeds to step S42.

In step S42, all the notification times equal to the current time are acquired from the notification queue table stored in the storage unit 16.

In step S43, the same notification destinations are summarized to generate a notification content. In step S44, all the notification messages are sent to notification destinations.

Thus, the processing procedure is completed.

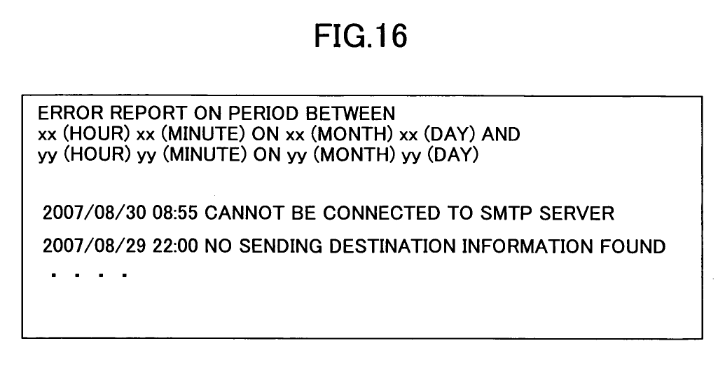

FIG. 16 is a diagram showing an example of the notification contents of an error notification.

In this example, the occurrence date and time of an error and the summary of the contents of the error notified by an error report are shown. The contents of the error are expressed so that the user can easily understand modes, such as “cannot be connected to SMTP server” and “no sending destination information found.”

### Fifth Embodiment

Next, a description is made of a fifth embodiment of the present invention.

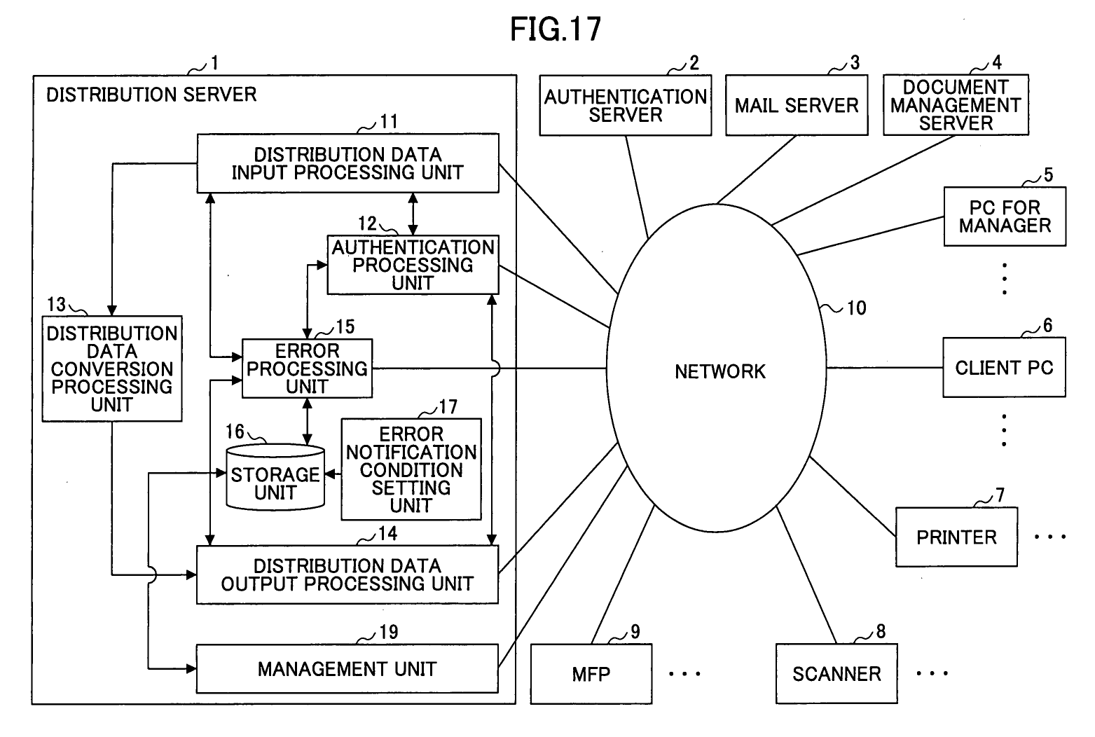

FIG. 17 is a block diagram showing the configurations of the data distribution apparatus and the data distribution system using the data distribution apparatus according to the fifth embodiment. The configurations of the data distribution apparatus and the data distribution system using the data distribution apparatus of the fifth embodiment are substantially the same as those of the first embodiment, except that the distribution server 1 as the data distribution apparatus of the fifth embodiment has a management unit 19. The management unit 19 is used for managing information on destinations, external input apparatuses such as the mail server 3 and the MFP 9, a manager, etc. Furthermore, the respective components of the data distribution apparatus and the data distribution system of the fifth embodiment corresponding to those of the first embodiment are denoted by the same reference numerals.

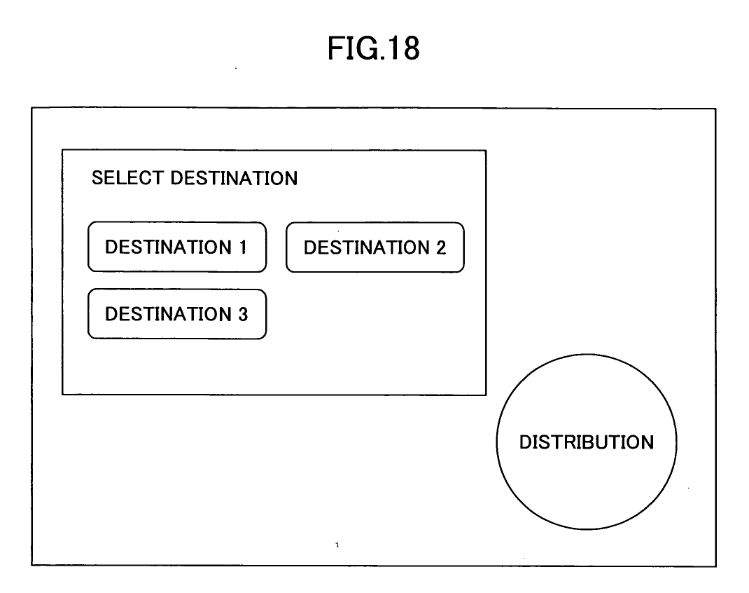

The distribution server 1 as the data distribution apparatus manages the sending destinations of plural managers or users with the destination information table described below. When the user selects a destination from a list of the destinations displayed on the external input apparatus such as the MFP 9, the distribution server 1 distributes the data of a scanned document, etc., to the sending destination associated with the selected destination. For example, when the MFP 9 is used as the external input apparatus, the operations screen shown in FIG. 18 is displayed. When the mail server 3 is used as the external input apparatus, a correspondence such as “distribution is made to destination 2 when a sender (From) is a@a.mail” is maintained in the distribution server 1. In this case, the attached file and the text of a mail rather than the data of the scanned document, etc., are distributed.

In the distribution server 1, the distribution data input processing unit 11 shown in FIG. 17 receives the data of a document file, a destination, etc., sent from the external input apparatus in normal mode. The distribution data conversion processing unit 13 converts the received data. The distribution data output processing unit 14 specifies the sending method associated with the destination by referring to the destination information table described below stored in the storage unit 16 and distributes the data converted according to the sending method to the sending destination. Prior to this distribution, the authentication processing unit 12 may perform authentication.

On the other hand, when an error occurs in the distribution data input processing unit 11, the distribution data output processing unit 14, the authentication processing unit 12, etc., of the distribution server 1, the error processing unit 15 records an error content in the error log table described below. By referring to the destination information table described below stored in the storage unit 16, the error processing unit 15 then notifies a notification destination such as a PC for a manager of the error. At this time, the error processing unit 15 has the characteristic of automatically determining an error notification object according to the type (input source) and the sending destination of the external input apparatus as an object where the error occurs.

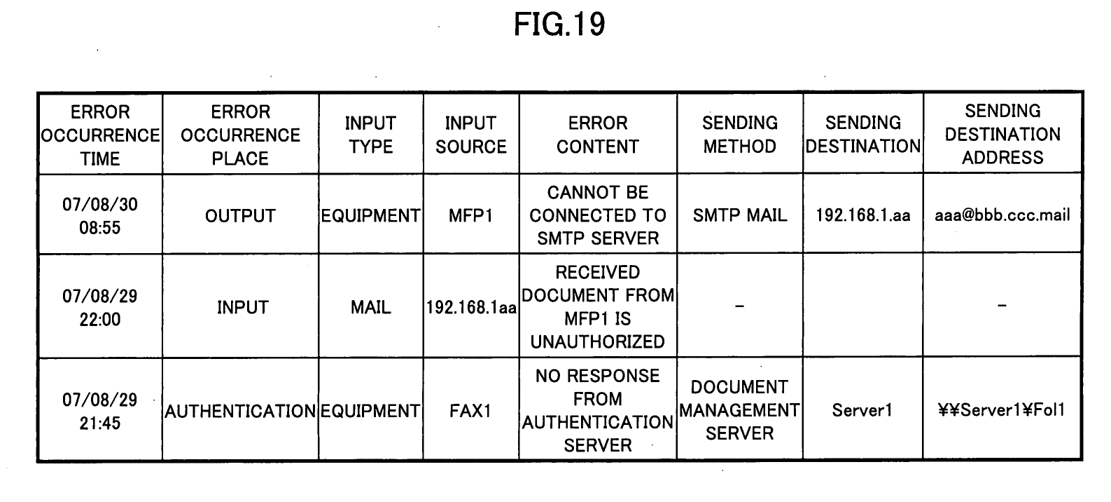

For example, when an error occurs at the distribution to the sending destination ¥¥Server1 (see FIG. 19) from the document management server 4 during output processing, the PC of the manager of the Server 1 is notified of an error message. When an error occurs at the distribution to destination 1 (FIG. 18), the PC of the manager or the user of the destination is notified of an error message.

Furthermore, the storage unit 16 stores an error log table, a destination information table, an input type information table, an input equipment information table, an input mail server information table, a distribution server manager information table, an authentication server manager information table, an output type information table, an output mail server information table, an output printer information table, and an output document management server information table. In other words, the storage unit 16 of this embodiment serves as an error log storage unit, a destination information storage unit, an input type information storage unit, an input equipment information storage unit, an input mail server information storage unit, a distribution server manger information storage unit, an authentication server manager information storage unit, an output type information storage unit, an output mail server information storage unit, an output printer information storage unit, and an output document management server information storage unit.

FIG. 19 is a diagram showing an example of the error log table used in the fifth embodiment.

In the error log table, error information items are managed. In other words, error occurrence times, error occurrence places, input types, input sources, error contents, sending methods, sending destinations, and sending destination addresses as the error information items are managed so as to correspond to each other.

The error occurrence time represents the times when it is determined that an error occurs on the side of the distribution server 1 where data are sent from the external input apparatus, etc. The error occurrence places represent, for example, the distribution data input processing unit 11 (input), the authentication processing unit 12 (authentication), and the distribution data output processing unit 14 (output).

The input types represent whether an error is caused by, for example, either equipment such as the MFP 9 as the external input apparatus or an electronic mail from the mail server 3.

The input sources represent specific external input apparatuses. The error contents represent specific error contents such as “cannot be connected to SMTP server.” The sending methods represent specific sending methods such as the SMTP mail and the document management server distribution. The sending destinations represent the names of sending destinations. The sending destination addresses represent the mail addresses of the sending destinations, etc.

As described above, the error log table includes information on the error contents. When determining the necessity of sending an error notification, the error processing unit 15 refers to the information on the error contents.

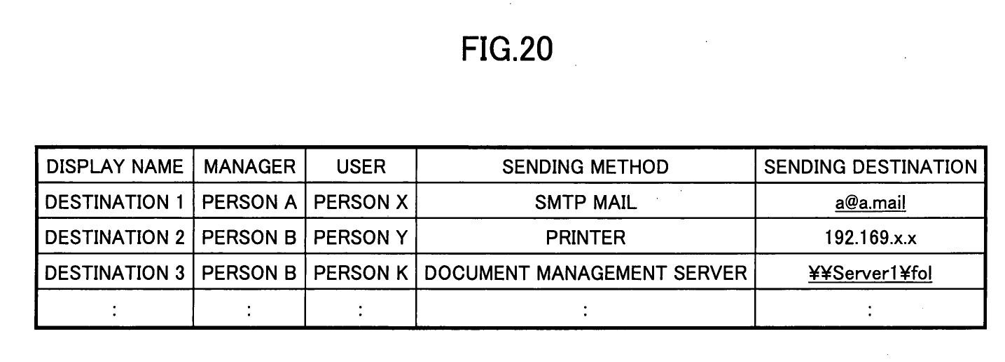

FIG. 20 is a diagram showing an example of the destination information table.

In the destination information table, destination information items are managed. In other words, display names, managers, users, sending methods, and sending destinations as the destination information items are managed so as to correspond to each other. The managers represent persons who control and manage prescribed groups. The users represent actual users.

The sending methods represent specific sending methods such as the SMTP mail and the document management server distribution. The sending destinations represent the names of sending destinations. Thus, the destination information table serves as a management unit that manages information on notification destinations related to user accounts.

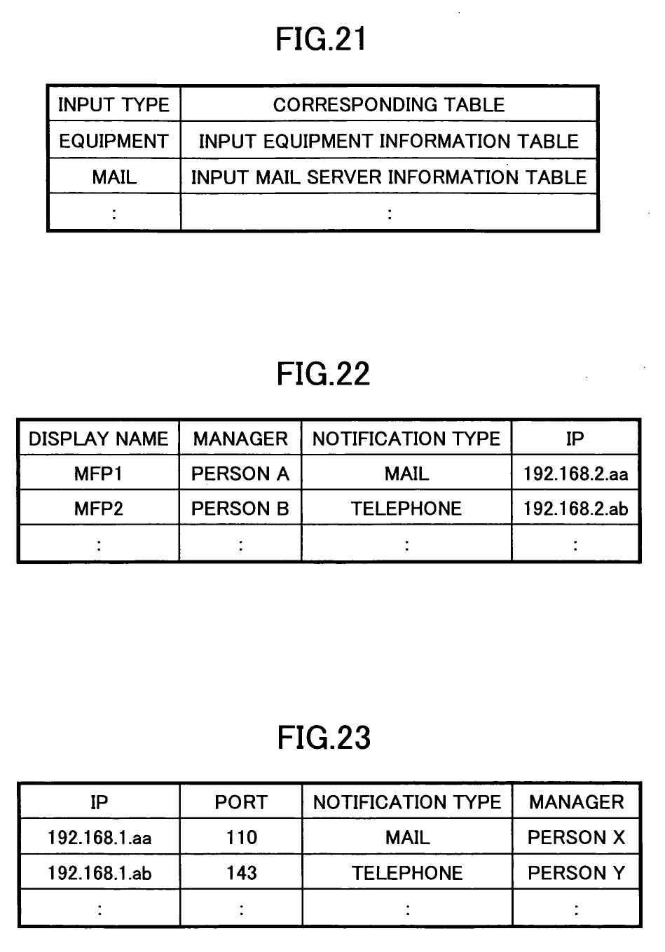

FIG. 21 is a diagram showing an example of the input type information table.

In the input type information table, input type information items are managed. In other words, input types and corresponding tables as the input type information items are managed so as to correspond to each other. In this table, the tables corresponding to the input types are specified. Specifically, an input equipment information table is specified as the corresponding table when the input type represents equipment, and an input mail server information table is specified as the corresponding table when the input type represents an electronic mail.

FIG. 22 is a diagram showing an example of the input equipment information table.

In the input equipment information table, display names, managers, notification types, and IP addresses as input equipment information items are managed so as to correspond to each other.

FIG. 23 is a diagram showing an example of the input mail server information table.

In the input mail server information table, input mail server information items are managed. In other words, IP addresses, ports, notification types, and managers as the input mail server information items are managed so as to correspond to each other. When the notification type represents an electronic mail, the error processing unit 15 refers to the input mail server information table.

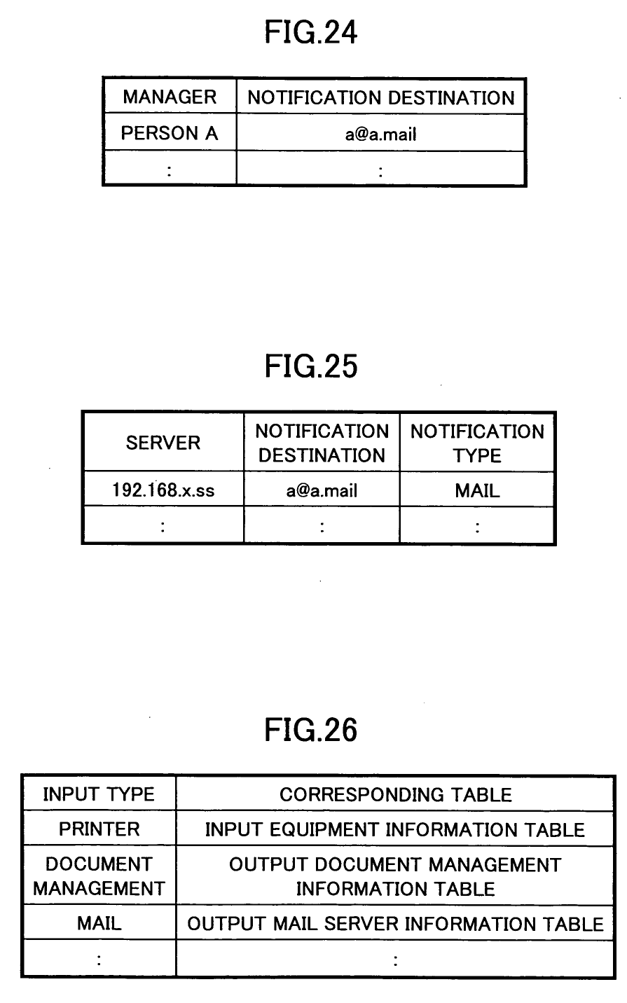

FIG. 24 is a diagram showing an example of the distribution server manager information table.

In the distribution server manager information table, managers and notification destinations as distribution server manager information items are managed as so as to correspond to each other.

FIG. 25 is a diagram showing an example of the authentication server manager information table.

In the authentication server manager information table, servers, notification destinations, and notification types as authentication server manager information items are managed so as to correspond to each other.

FIG. 26 is a diagram showing an example of the output type information table.

In the output type information table, input types and corresponding tables as input type information items are managed so as to correspond to each other. For example, an input equipment information table, an output document management server information table, and an output mail server information table are specified as tables to be referred to when the input types represent a printer, a document management server, and an electronic mail, respectively.

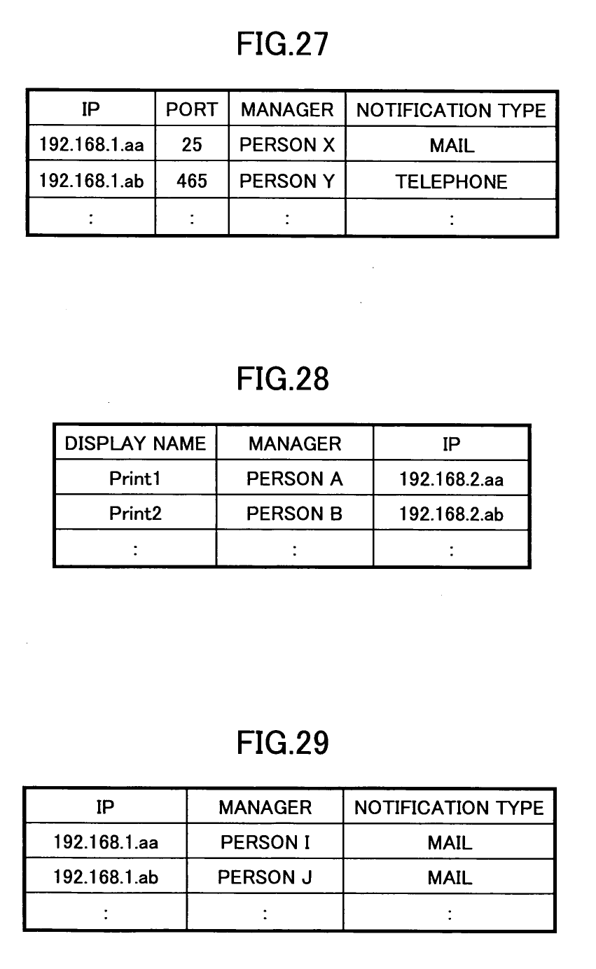

FIG. 27 is a diagram showing an example of the output mail server information table.

In the output mail server information table, IP addresses, ports, managers, and notification types as output mail server information items are managed so as to correspond to each other.

FIG. 28 is a diagram showing an example of the output printer information table.

In the output printer information table, display names, managers, and IP addresses of printers as output printer information items are managed so as to correspond to each other.

FIG. 29 is a diagram showing an example of the output document management server information table.

In the output document management server information table, IP addresses, managers, and notification types as output document management server information items are managed so as to correspond to each other.

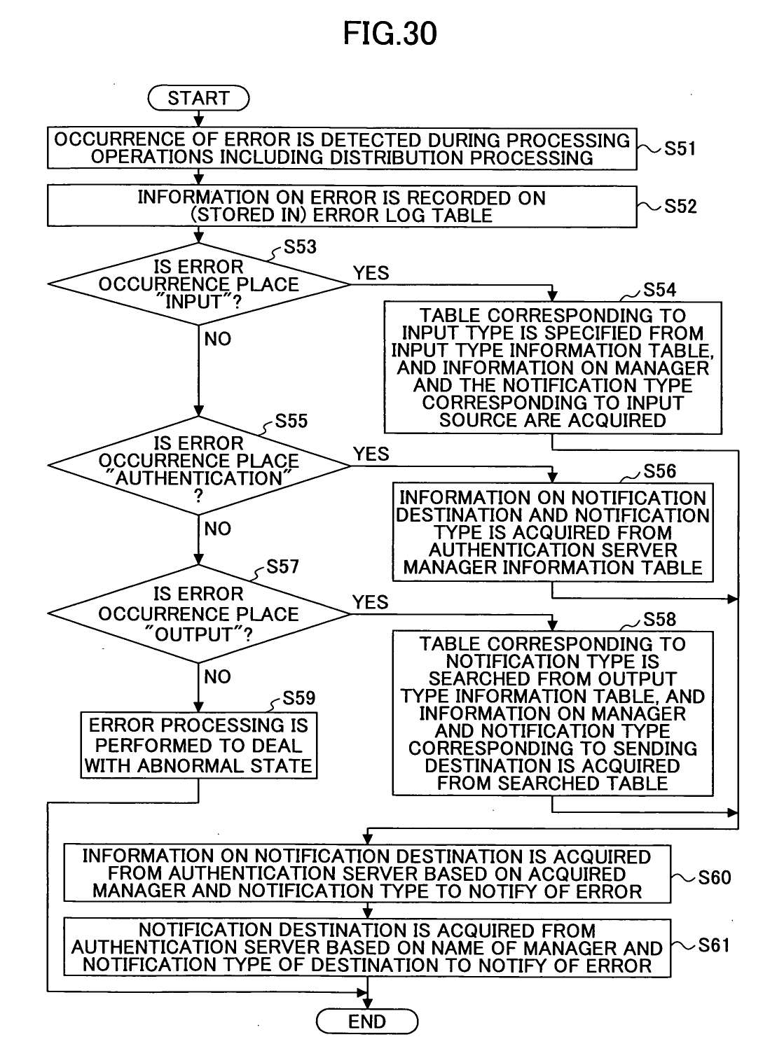

FIG. 30 is a flowchart showing a processing procedure performed by the error processing unit 15 of the data distribution apparatus at the occurrence of an error according to the fifth embodiment of the present invention.

In step S51, the occurrence of the error is detected during processing operations including distribution processing. In step S52, information on the error is recorded in (stored in) the error log table of the storage unit 16.

In step S53, it is determined whether an error occurrence place is the “input (i.e., whether the error occurs at the distribution data input processing unit 11).” When it is determined that the error occurrence place is the “input” in step S53, the process proceeds to step S54. On the other hand, when it is determined that the error occurrence place is not the “input” in step S53, the process proceeds to step S55.

In step S54, the table corresponding to the input type is specified from the input type information table stored in the storage unit 16, and then information on the manager and the notification type corresponding to the input source are acquired.

In step S55, it is determined whether the error occurrence place is the “authentication (i.e., whether the error occurs at the authentication processing unit 12).”

When it is determined that the error occurrence place is the “authentication” in step S55, the process proceeds to step S56. On the other hand, when it is determined that the error occurrence place is not the “authentication” in step S55, the process proceeds to step S57. In step S56, information on the notification destination and the notification type is acquired from the authentication server manager information table stored in the storage unit 16.

In step S57, it is determined whether the error occurrence place is the “output (i.e., whether the error occurs at the distribution data output processing unit 14).”

When it is determined that the error occurrence place is the “output” in step S57, the process proceeds to step S58. On the other hand, when it is determined that the error occurrence place is not the “output” in step S57, the process proceeds to step S59. In step S58, the table corresponding to the notification type is searched for from the output type information table stored in the storage unit 16, and then information on the name of the manager and the notification type corresponding to the sending destination is acquired from the searched table.

In step S59, error processing is performed to deal with an abnormal state. In step S60, information on the notification destination is acquired from the authentication server 12 based on the acquired name of the manager and the notification type to notify of the error. In step S61, the notification destination is acquired from the authentication server 12 based on the name of the manager and the notification type of the destination to notify of the error.

Thus, a series of processing is completed.

### Sixth Embodiment

Next, a description is made of a sixth embodiment of the present invention.

The configurations of the data distribution apparatus and the data distribution system using the data distribution apparatus of the sixth embodiment are substantially the same as those of the fifth embodiment. Therefore, the respective components of the data distribution apparatus and the data distribution system of the sixth embodiment corresponding to those of the fifth embodiment are denoted by the same reference numerals.

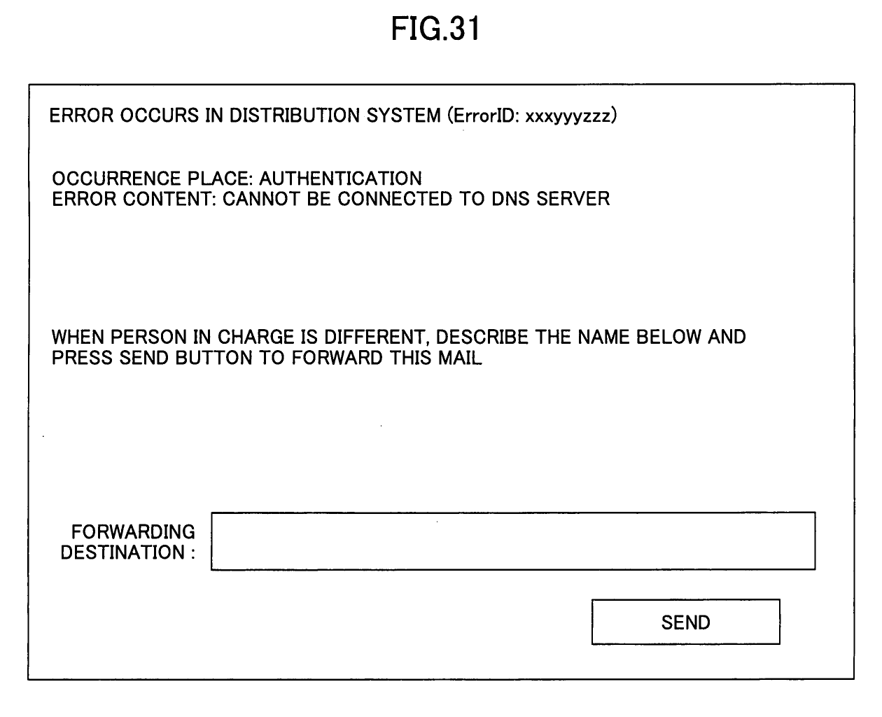

The data distribution system of this embodiment is capable of setting exception conditions. FIG. 31 is a diagram showing an example of an error notification mail that the PC for a manager receives. In this example, an error occurrence place and an error content are displayed, which prompts the user to input a forwarding destination. When the user inputs the forwarding destination in a forwarding destination box and presses a send button, a reply mail is sent to the distribution server 1 and a forwarding object. The distribution server 1 extracts error conditions based on an error ID and then records the error conditions and the forwarding destination in the exception condition information table of the storage unit 16 so as to correspond to each other.

Accordingly, in this case, information on a notification destination is information on the destination specified at the occurrence of the error. Note that when a first notification destination initially receiving an error notification forwards the error notification, information on a second notification destination as the forwarding destination may be used as information on the subsequent notification destination.

Alternatively, in a case where the first notification destination initially receiving the error notification forwards the error notification about the same error content to the same forwarding destination for a prescribed time or more when forwarding the error notification, the second notification destination as the forwarding destination may be used as the information on the subsequent notification destination.

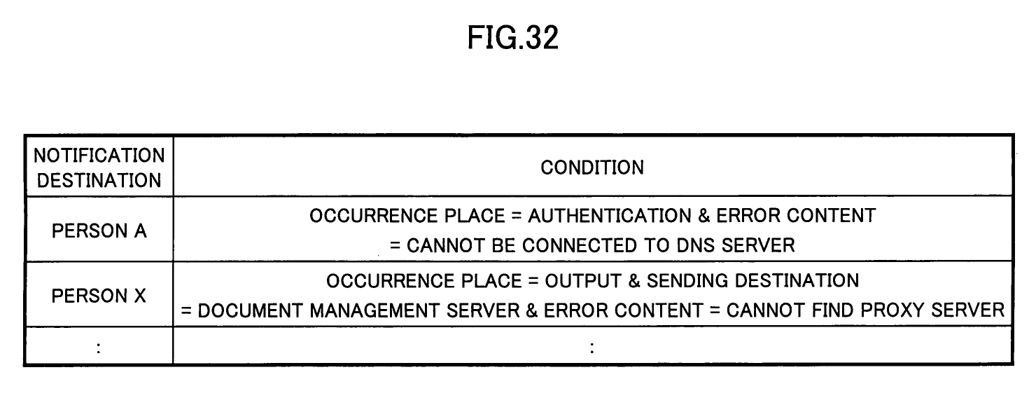

FIG. 32 is a diagram showing an example of the exception condition information table in this case. In the exception condition information table, notification destinations and conditions as exception condition information items are managed so as to correspond to each other.

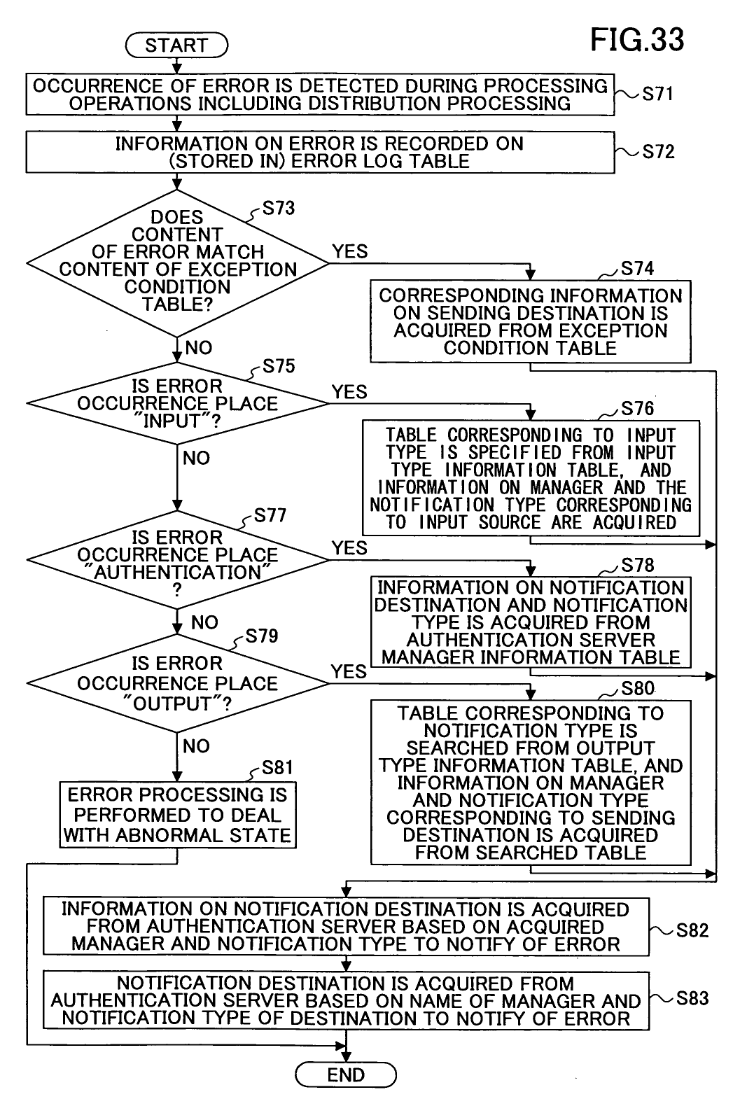

FIG. 33 is a flowchart showing a processing procedure performed by the error processing unit 15 of the data distribution apparatus at the occurrence of an error according to the sixth embodiment of the present invention.

In step S71, the occurrence of the error is detected during processing operations including distribution processing. In step S72, information on the error is recorded in (stored in) the error log table of the storage unit 16.

In step S73, it is determined whether a error content matches the content of the exception condition table stored in the storage unit 16. When it is determined that the error content does not match the exception condition table in step S73, the process proceeds to step S75.

On the other hand, when it is determined that the error content matches the exception condition table in step S73, the process proceeds to step S74. In step S74, corresponding information on the sending destination is acquired from the exception condition table.

The processing from steps S75 through S83 is the same as that from steps S53 through S61 of FIG. 30. Therefore, their duplicated descriptions are omitted here.

According to the first through sixth embodiments of the present invention, a notification destination for sending an error notification is not limited to the PC for a manager when an error occurs. Therefore, manager work loads are distributed, and an appropriate notification destination and appropriate timing for sending the error notification are controlled.

According to the first embodiment, the necessity of sending an error notification is properly determined by the occurrence frequencies, i.e., the occurrence numbers and the occurrence intervals. Therefore, the manager work loads are reduced.

According to the second embodiment, the necessity of sending an error notification is properly determined by the continuous occurrence conditions, i.e., the continuous occurrence numbers. Therefore, the manager work loads are reduced.

According to the third embodiment, the necessity of sending an error notification is properly determined based on either the occurrence frequencies or the continuous occurrence conditions when the notification determination methods are specified. Therefore, the manager work loads are reduced.

According to the fourth embodiment, an error notification is collectively sent at an appropriate time based on information on a notification time in accordance with the notification job scheduler. Therefore, loads on the network are distributed, and the manager work loads receiving the error notification are reduced.

According to the fifth embodiment, a corresponding table is selected based on the input type to specify the manager and the notification type. Therefore, an error notification can be more properly sent.

According to the sixth embodiment, an error notification can be sent based on the exception conditions, which results in an improvement in flexibility. Therefore, convenience for the user is also improved.

In the respective embodiments described above, the distribution server as an example of the data distribution apparatus according to the present invention and the data distribution system using the distribution server are mainly described. Furthermore, the processing procedure performed by the distribution server 1 (performed mainly by the error processing unit 15) in the respective embodiments is described using the flowcharts. The processing procedure in the respective embodiments corresponds to an error notification method according to an embodiment of the present invention.

Furthermore, a program, which causes the PC used as the distribution server to perform the processing procedure shown in the flowcharts, corresponds to a program according to an embodiment of the present invention. Moreover, a computer-readable recording medium such as a flexible disk, a CD-ROM, a memory card, and a memory chip having the program recorded thereon corresponds to a recording medium according to an embodiment of the present invention.

When the program is downloaded into the PC used as the distribution server via a network, or when it is read from the recording medium and stored in a hard disk, etc., of the PC, the PC serves as the data distribution apparatus according to the embodiments of the present invention.

The embodiments of the present invention can be applied to various data distribution systems in which various image processing apparatuses such as a facsimile machine, a printer, a copier, and a digital multi-function peripheral and an information processing apparatus (including one used as a server) such as a PC, which serve as a distribution source apparatus or a distribution destination apparatus, are connected to a data distribution apparatus via a network so as to perform data communications.

According to the embodiments of the data distribution apparatus, the data distribution system, the data distribution method, the data distribution program, and the recording medium having recorded thereon the data distribution program, it is possible to automatically send an error notification to information processing terminals other than the information processing terminal for a manager so as to reduce working loads when the manager uses the data distribution apparatus.

The present invention is not limited to the specifically disclosed embodiments, and variations and modifications may be made without departing from the scope of the present invention.

The present application is based on Japanese Priority Application No. 2008-068856 filed on Mar. 18, 2008, the entire contents of which are hereby incorporated herein by reference.

What is claimed is:

1. An error notification method of a data distribution system in which a data distribution apparatus is connected to a distribution source apparatus and a distribution destination apparatus via a network and distributes data acquired from the distribution source apparatus to the required distribution destination apparatus, the method comprising the steps of:
when detecting an occurrence of an error, referring to an error notification condition table in which an identifier of an error notification condition and an identifier of an occurrence frequency correspond to each other to specify the identifier of the occurrence frequency corresponding to the identifier of the error notification condition of the error;
referring to an occurrence frequency table in which the identifier of the occurrence frequency and information on a frequency number and an occurrence interval correspond to each other to acquire the information on the occurrence number and the occurrence interval corresponding to the identifier of the occurrence frequency; and
determining whether an error notification is sent based on the information on the occurrence number and the occurrence interval.

2. The error notification method according to claim 1, wherein
the identifier of the error notification condition and the identifier of the occurrence frequency and information on a determination condition correspond to each other in the error notification condition table, and
the determination as to whether the error notification is sent is based on the information on the occurrence number and the occurrence interval and the information on the determination condition.

3. The error notification method according to claim 1, wherein
an identifier of a continuous occurrence condition substituting for the identifier of the occurrence frequency corresponds to the identifier of the error notification condition in the error notification condition table,
a continuous occurrence condition table substituting for the occurrence frequency table is stored in which the identifier of the continuous occurrence condition and information on a continuous occurrence number correspond to each other, and
the determination as to whether the error notification is sent is based on the information on the continuous occurrence number corresponding to the identifier of the continuous occurrence condition of the error substituting for the information on the occurrence number and the occurrence interval.

4. The error notification method according to claim 3, wherein
the identifier of the error notification condition corresponds to the identifier of the continuous occurrence condition and the information on determination condition in the error notification condition table, and
the determination as to whether the error notification is sent is based on whether the error matching the determination condition continuously occurs for the continuous occurrence number.

5. The error notification method according to claim 1, wherein
a continuous occurrence condition table in which an identifier of a continuous occurrence condition and information on a continuous occurrence number correspond to each other is stored in addition to the occurrence frequency table,
information on a notification determination method showing which one of the occurrence frequency table and the continuous occurrence condition table should be referred to corresponds to the identifier of the error notification condition in the error notification condition table, and
one of the occurrence frequency table and the continuous occurrence condition table is referred to in accordance with the information on the notification determination method in determining whether the error notification is sent.

6. The error notification method according to claim 1, wherein
information on a notification time for the error notification is further included in the error notification condition table, and
the error notification is sent based on the information on the notification time when it is determined that the error notification should be sent.

7. A data distribution apparatus that is connected to a distribution source apparatus and a distribution destination apparatus via a network and distributes data acquired from the distribution source apparatus to the required distribution destination apparatus, the apparatus comprising:
a storage unit that stores an error notification condition table in which an identifier of an error notification condition and an identifier of an occurrence frequency correspond to each other and an occurrence frequency table in which the identifier of the occurrence frequency and information on an occurrence number and an occurrence interval correspond to each other; and
an error processing unit that, when detecting an occurrence of an error, refers to the error notification condition table of the storage unit to specify the identifier of the occurrence frequency corresponding to the identifier of the error notification condition of the error, refers to the occurrence frequency table of the storage unit to acquire the information on the occurrence number and the occurrence interval corresponding to the specified identifier of the occurrence frequency, and determines whether an error notification is sent based on the information on the occurrence number and the occurrence interval.

8. The data distribution apparatus according to claim 7, wherein
the storage unit stores plural tables in which information on a manager and information on a notification destination correspond to each other for each error occurrence place, and,
an error processing unit specifies, when detecting the occurrence of the error, a corresponding one of the plural tables of the storage unit to acquire the information on the manager and the notification destination based on the information on the error occurrence place and sends the error notification based on the information.

9. The data distribution apparatus according to claim 8, wherein
the storage unit stores information on an error content, and
the error processing unit specifies the notification destination for the error notification from the notification destinations of the plural tables based on the error content that matches the detected error.

10. The data distribution apparatus according to claim 9, wherein
the storage unit stores information on a notification type, and
the error processing unit specifies the notification destination for the error notification based on the information on the notification type that matches the detected error.

11. The data distribution apparatus according to claim 8, wherein
the information on the notification destination represents information on a destination specified at the occurrence of the error.

12. The data distribution apparatus according to claim 8, wherein,
when a first notification destination initially receiving the error notification forwards the error notification, information on a second notification destination to which the error notification is forwarded serves as information on a subsequent notification destination.

13. The data distribution apparatus according to claim 9, wherein
in a case where a first notification destination initially receiving the error notification forwards the error notification about a same error content to a same forwarding destination for a prescribed time or more when forwarding the error notification, information on a second notification destination to which the error notification is forwarded serves as information on a subsequent notification destination.

14. A computer-readable recording medium having recorded thereon a program that causes a computer of a data distribution apparatus, which is connected to a distribution source apparatus and a distribution destination apparatus via a network and distributes data acquired from the distribution source apparatus to the required distribution destination apparatus, to perform, when detecting an occurrence of an error, a processing step of referring to an error notification condition table in which an identifier of an error notification condition and an identifier of an occurrence frequency correspond to each other to specify the identifier of the occurrence frequency corresponding to the identifier of the error notification condition of the error; a processing step of referring to an occurrence frequency table in which the identifier of the occurrence frequency and information on a frequency number and an occurrence interval correspond to each other to acquire the information on the occurrence number and the occurrence interval corresponding to the identifier of the occurrence frequency; and a processing step of determining whether an error notification is sent based on the information on the occurrence number and the occurrence interval.
